(19) United States
(12) Patent Application Publication
(10) Pub. No.: US 2012/0053709 A1
(43) Pub. Date: Mar. 1, 2012

(54) SYSTEM AND METHOD FOR CLOCK SELF-ADJUSTMENT IN AUDIO COMMUNICATIONS SYSTEMS

(75) Inventors: JANE ZHENG, San Jose, CA (US); Zhibing Liu, San Jose, CA (US); Jay Liang, Los Altos, CA (US)

(73) Assignee: Integrated Device Technology, Inc.

(21) Appl. No.: 12/870,619

(22) Filed: Aug. 27, 2010

(51) Int. Cl. G06F 17/00

(52) U.S. Cl. 700/94

(57) ABSTRACT

System and method for implementing a self-adjusting audio clock in an audio receiver comprising an audio data buffer for buffering data received from a transmitter are described. In one embodiment, the system includes an audio clock recovery circuit for recovering an audio clock signal from a reference clock signal received from the transmitter, wherein the audio clock is provided to the audio data buffer for use in reading data therefrom. The system further includes an adjustment circuit for providing an adjustment signal to the audio clock recovery circuit in accordance with a status of the audio data buffer. Responsive to the status of the audio data buffer indicating that the audio data buffer is approaching overflow, the adjustment signal provided to the audio clock recovery circuit causes an increase in the frequency of the audio clock signal. Responsive to the status of the audio data buffer indicating that the audio data buffer is approaching underflow, the adjustment signal provided to the audio clock recovery circuit causes a decrease in the frequency of the audio clock signal.

### BACKGROUND

1. Technical Field

One embodiment relates to clock signals used in audio communication systems and, more specifically, to system and method for self-adjustment of the frequency of a clock signal used in audio communication systems.

2. Description of the Related Arts

In many audio communication systems, the audio clock employed at the receiver is a locally recovered clock. Examples include, but are not limited to, DisplayPort and HDMI. In such systems, the transmitter sends a pair of values, hereinafter designated “M” and “N” values, to the receiver along with a unique commonly shared clock. In the case of DisplayPort, the clock signal is referred to as the “link symbol clock.” The receiver is expected to use this clock as the reference clock and to use a certain type of phase locked loop (“PLL”) circuit to recover the audio clock based on the following equation:

audio_clock_frequency=(commonly_shared_clock_frequency)*M/N

Unfortunately, all types of PLLs are prone to a certain amount of jitter and wander. Moreover, the clock difference may be cumulative over time, meaning that the audio buffer, typically implemented as a first-in, first-out (“FIFO”) buffer, will inevitably experience over- or under-flow if corrective measures are not implemented. This scenario might be particularly troublesome for compressed audio data streams, such as Sony/Phillips Digital Interconnect Format (“S/PDIF”).

Therefore, there is a need for an audio clock signal that self-adjusts its frequency in response to the state of the audio buffer.

### SUMMARY

In accordance with some embodiments, a system for implementing a self-adjusting audio clock in an audio receiver comprising an audio data buffer for buffering data received from a transmitter is described. The system includes an audio clock recovery circuit for recovering an audio clock signal from a reference clock signal received from the transmitter. The audio clock can be provided to the audio data buffer for use in reading data therefrom. An adjustment circuit can provide an adjustment signal to the audio clock recovery circuit in accordance with a status of the audio data buffer. Responsive to the status of the audio data buffer indicating that the audio data buffer is approaching overflow, the adjustment signal provided to the audio clock recovery circuit causes an increase in the frequency of the audio clock signal. Responsive to the status of the audio data buffer indicating that the audio data buffer is approaching underflow, the adjustment signal provided to the audio clock recovery circuit causes a decrease in the frequency of the audio clock signal.

Another embodiment for providing a self-adjusting audio clock in an audio receiver includes an audio data buffer for buffering data received from a transmitter. The method includes determining a number of entries stored in an audio data buffer; responsive to the determined number of entries being greater than an upper threshold, increasing an audio clock frequency by a first predetermined amount; and responsive to the determined number of entries being less than a lower threshold, decreasing the audio clock frequency by a second predetermined amount.

Yet another embodiment of providing a self-adjusting audio clock in an audio receiver includes an audio data buffer for buffering data received from a transmitter. The method comprises determining a status of the audio data buffer for buffering audio data received from a transmitter; responsive to a determination that the status of the audio data buffer is approaching overflow, providing an adjustment signal to an audio clock recovery circuit for recovering an audio clock from a reference clock received from the transmitter to increase a frequency of the audio clock; and responsive to a determination that the status of the audio data buffer is approaching underflow, providing an adjustment signal to the audio clock recovery circuit to decrease the frequency of the audio clock.

These and other embodiments are further described below with reference to the following figures.

### BRIEF DESCRIPTION OF THE DRAWINGS

The teachings of the embodiments described herein can be readily understood by considering the following detailed description in conjunction with the accompanying drawings.

FIG. 1 is a block diagram of a transmitter/receiver pair embodying features of one embodiment.

FIG. 2 is a block diagram of an audio clock recovery circuit for use in the receiver of FIG. 1.

FIG. 3 is a block diagram of an audio system embodying features of one embodiment.

FIG. 4 illustrates adjustment of the audio clock recovery circuit of FIG. 3 based on the status of the audio buffer thereof in accordance with one embodiment.

### DETAILED DESCRIPTION OF EMBODIMENTS

The Figures and the following description relate to some embodiments of the present invention by way of illustration only. It should be noted that from the following discussion, alternative embodiments of the structures and methods disclosed herein will be readily recognized as viable alternatives that may be employed without departing from the principles of the present invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

A clock self-adjustment scheme for use in an audio communications system is described. In some embodiments, minor changes are introduced to the audio clock frequency so as to prevent the audio buffer from over- or under-flowing. As a result, accumulated clock difference will be removed by dynamic adjustment of the clock frequency. The net result is that the average clock frequency is maintained well enough to match the transmitter audio clock over long periods of time so that the audio data will not be corrupted by buffer over- or under-flow. The embodiments are effective despite the constant, minor changes in clock frequency that occur over time.

The embodiments will be described herein with reference to a DisplayPort application; however, it will be recognized that similar approaches will be applicable to other audio transmitting standards, such as HDMI, for example. FIG. 1 is a block diagram of a portion of an audio communications system 100 including a transmitter 102 and receiver 104. As shown in FIG. 1, the receiver 104 includes a serializer/deserializer (“SerDes”) 106, an audio clock recovery circuit 108, and an audio recovery module 110. The SerDes 106 processes the signal received from the transmitter (represented by an arrow 111) and provides audio M and N values received from the transmitter to the audio clock recovery circuit 108, as represented by an arrow 112, and audio data to the audio recovery module 110, as represented by an arrow 114. The SerDes 106 further recovers the link symbol clock from the data received from the transmitter 102 and provides it to the audio clock recovery circuit 108 as the reference clock, as represented by an arrow 118.

The output of the clock recovery circuit, which serves as the audio clock for the receiver 104, is described by the following equation:

PLL_output_signal=(M/N)*link_symbol_clock_frequency

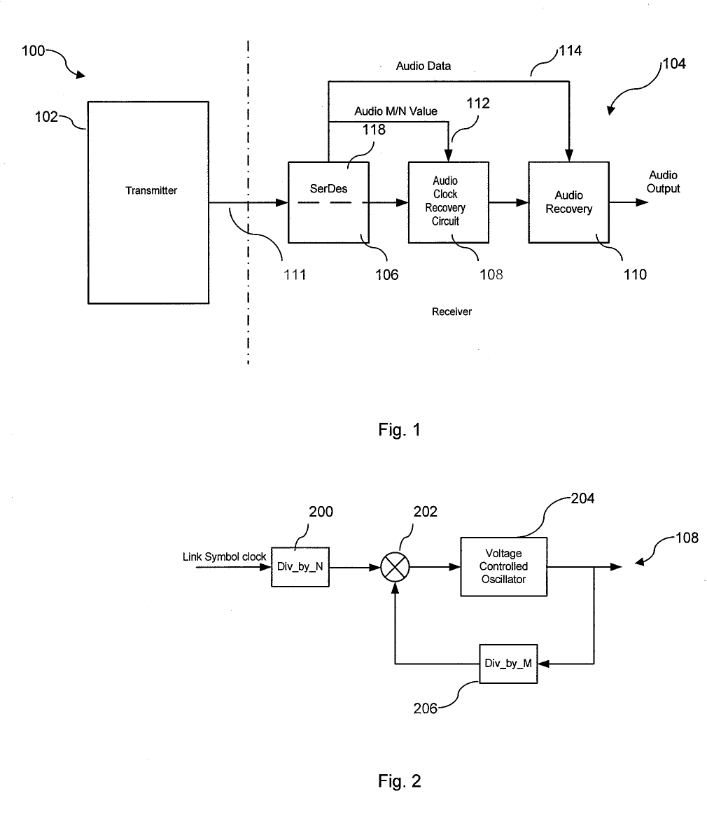

FIG. 2 is a more detailed block diagram of an example of the audio clock recovery circuit 108 of FIG. 1 for generating the audio clock from the link symbol clock. As shown in FIG. 2, the audio clock recovery circuit 108 can be a PLL that generates a PLL_output_signal utilized by the audio recovery circuit 110. As illustrated in FIG. 2, the link symbol clock is input to a divide by N circuit 200, the output of which is input to a compensator circuit 202. The output of a voltage controlled oscillator (“VCO”) 204 is input to a divide by M circuit 206, the output of which is combined with the output of the divide by N circuit 200 by the circuit 202 and input to the VCO 204. The circuit 202 controls the VCO 204 so that its inputs are equal.

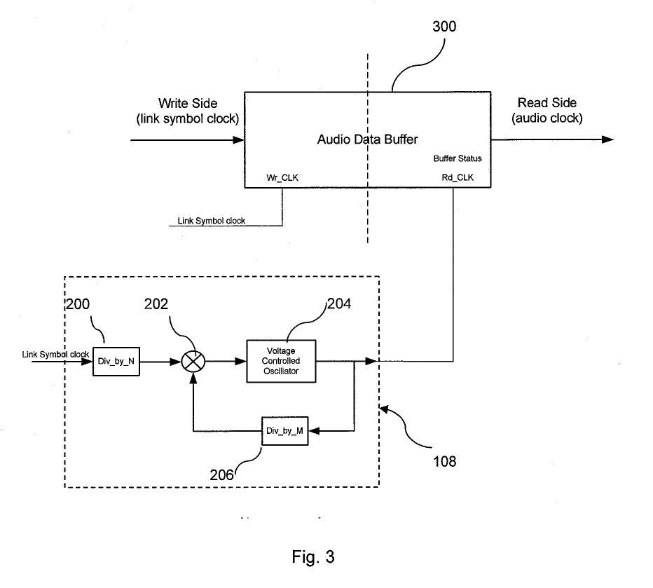

It will be recognized that in DisplayPort standard 1.1a, the frequency of the link symbol clock, denoted as “link_clock_frequency,” may be either 270 MHz or 162 MHz for high bit rate and reduced bit rate, respectively. As shown in FIG. 3, audio recovery circuit 110 can include audio data buffer 300. Audio data buffer 300 can be of any size. As also shown in FIG. 3, the link symbol clock is used to perform write operations to the audio data buffer 300 of the audio recovery circuit 110 (FIG. 1), while the output clock signal generated by the audio clock recovery circuit 108 is used for read operations performed on the audio data buffer. From the perspective of the entire audio system, the approach illustrated in FIG. 3 is an open loop approach in which there is no mechanism provided to guarantee the audio data buffer 300 will never be corrupted due to the clock difference between the transmitter 102 and receiver 104.

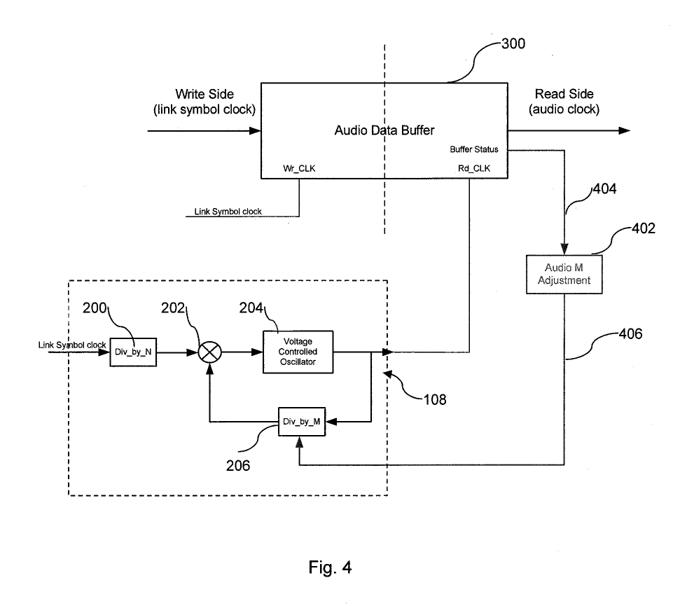

In accordance with some embodiments of the present invention, a mechanism for dynamically adjusting the audio clock frequency based on a status of the audio data buffer 300 is provided. In particular, the frequency of the audio clock will be increased slightly if the buffer 300 is close to over-flowing and will be decreased slightly if the buffer 300 is close to under-flowing. An example is illustrated in FIG. 4. In particular, a buffer status signal from the audio buffer 300 is input to an adjustment circuit 402. The adjustment circuit 402 then provides and adjustment signal to the audio clock recovery circuit 108, which adjusts the frequency of the audio clock accordingly. As described below, in some embodiments, the adjustment circuit 402 adjusts the value of M utilized by the divide by M circuit in accordance with the buffer status signal provided thereto and provides an updated M value signal to the divide by M circuit 206, as represented by an arrow 406, to effectively change the frequency of the audio clock output from the audio clock recovery circuit 108.

Operation of the adjustment circuit 402 will now be described. Various programmable parameters are employed in the system that render the embodiments described herein flexible. First, the number of valid data entries buffered in the buffer 300 is maintained and two thresholds can be defined (e.g., via programmable registers internal to the buffer 300), including an upper threshold and a lower threshold. If the number of entries in the buffer is between these two thresholds, no audio clock adjustment needs to occur; conversely, if the number of buffer entries is greater than the upper threshold or less than the lower threshold, the audio clock should be adjusted so as to increase or decrease the rate at which data is being read from the buffer relative to the rate at which data is being input to the buffer. Accordingly, a delta M value is defined for use in adjusting the frequency of the audio clock as needed. As will be described below, if the number of valid entries in the buffer is greater than the upper threshold, the delta M value is added to the audio M value from the transmitter, thereby increasing the M value, and hence the frequency of the audio clock. Conversely, if the number of valid entries in the buffer is less than the lower threshold, the delta M value is subtracted from the audio M value from the transmitter, thereby decreasing the M value, and hence the frequency of the audio clock.

In operation, the buffer status signal 404 provided to the M adjustment circuit 402 indicates whether the number of entries in the buffer is greater than the upper threshold or less than the lower threshold. If the buffer status signal 404 indicates that the number of entries in the buffer 300 is greater than the upper threshold, indicating that data is being written to the buffer more quickly than it is being read from the buffer (i.e., the frequency of the link symbol clock is greater than that of the audio clock), the M adjustment circuit 402 adds the delta M value to the M value received from the transmitter and the new M value is provided from the circuit 402 to the divide by M circuit 206. The result of these operations is to increase the frequency of the audio clock, thereby increasing the speed at which data is read from the buffer to closely match the speed at which it is written thereto.

Conversely, if the buffer status signal 404 indicates that the number of entries in the buffer 300 is less than the lower threshold, indicating that data is being read from the buffer more quickly than it is being written thereto (i.e., the frequency of the link symbol clock is less than that of the audio clock), the M adjustment circuit 402 subtracts the delta M value from the M value received from the transmitter and the new M value is provided from the circuit 402 to the divide by M circuit 206. The result of these operations is to decrease the frequency of the audio clock, thereby decreasing the speed at which data is read from the buffer to closely match the speed at which it is written thereto.

It will be noted that the value of delta M is programmable and/or selectable such that an appropriate amount of change in frequency can be affected by the adjustment circuit 402. Moreover, different delta M values may be used for incrementing and decrementing the value of M as desired. It should also be noted that, instead of varying the value of M in the audio clock recovery circuit 108, the value of N may be adjusted to effect an adjustment to the frequency. In operation, the value of N would be adjusted opposite of the adjustments described above for adjusting the value of M.

Upon reading this disclosure, those of skill in the art will appreciate still additional alternative designs or implementation details for the embodiments described herein. Thus, while particular embodiments and applications have been illustrated and described, it is to be understood that the embodiments are not limited to the precise construction and components disclosed herein and that various modifications, changes and variations which will be apparent to those skilled in the art may be made in the arrangement, operation and details of the method and apparatus of the embodiments disclosed herein without departing from the spirit and scope thereof.

What is claimed is:

1. A system for implementing a self-adjusting audio clock in an audio receiver having an audio data buffer for buffering data received from a transmitter, the system comprising:
an audio clock recovery circuit for recovering an audio clock signal from a reference clock signal received from the transmitter, wherein the audio clock is provided to the audio data buffer for use in reading data therefrom;
an adjustment circuit for providing an adjustment signal to the audio clock recovery circuit in accordance with a status of the audio data buffer;
wherein responsive to the status of the audio data buffer indicating that the audio data buffer is approaching overflow, the adjustment signal provided to the audio clock recovery circuit causes an increase in the frequency of the audio clock signal; and
wherein responsive to the status of the audio data buffer indicating that the audio data buffer is approaching underflow, the adjustment signal provided to the audio clock recovery circuit causes a decrease in the frequency of the audio clock signal.

2. The system of claim 1 wherein the audio clock recovery circuit comprises a phase locked loop (“PLL”).

3. The system of claim 1 wherein the audio data buffer provides a buffer status signal to the adjustment circuit indicative of the status of the audio data buffer.

4. The system of claim 4 wherein the adjustment signal adjusts an M value provided by the transmitter and used by the PLL to recover the audio clock.

5. The system of claim 4 wherein the adjustment signal causes an incremental increase in the M value responsive to the audio data buffer status indicating that the audio data buffer is approaching overflow.

6. The system of claim 4 wherein the adjustment signal causes an incremental decrease in the M value responsive to the audio data buffer status indicating that the audio data buffer is approaching underflow.

7. The system of claim 1 wherein the audio data buffer is determined to be approaching overflow when a number of entries stored therein is greater than an upper threshold.

8. The system of claim 1 wherein the audio data buffer is determined to be approaching underflow when a number of entries stored therein is less than a lower threshold.

9. The system of claim 1 wherein the buffer is a first-in, first-out (“FIFO”) buffer.

10. A method for providing a self-adjusting audio clock in an audio receiver having an audio data buffer for buffering data received from a transmitter, the method comprising:
determining a number of entries stored in an audio data buffer;
responsive to the determined number of entries being greater than an upper threshold, increasing an audio clock frequency by a first predetermined amount;
responsive to the determined number of entries being less than a lower threshold, decreasing the audio clock frequency by a second predetermined amount.

11. The method of claim 10 wherein the first and second predetermined amounts are the same.

12. The method of claim 10 wherein the audio clock is recovered from a reference clock received from the transmitter using a recovery circuit.

13. The method of claim 12 wherein the recovery circuit comprises a phase locked loop and the audio clock is recovered from the reference clock according to the equation:
audio clock frequency=(M/N)*reference clock frequency
wherein M and N are values provided to the receiver by the transmitter.

14. The method of claim 13 wherein the increasing the audio clock frequency further comprises incrementing a value of M input to the PLL by a value delta M.

15. The method of claim 13 wherein the decreasing the audio clock frequency further comprises decrementing the value of M input to the PLL by a value delta M.

16. A method of providing a self-adjusting audio clock in an audio receiver, the audio receiver having an audio data buffer for buffering data received from a transmitter, the method comprising:
determining a status of the audio data buffer for buffering audio data received from a transmitter;
responsive to a determination that the status of the audio data buffer is approaching overflow, providing an adjustment signal to an audio clock recovery circuit for recovering an audio clock from a reference clock received from the transmitter to increase a frequency of the audio clock; and
responsive to a determination that the status of the audio data buffer is approaching underflow, providing an adjustment signal to the audio clock recovery circuit to decrease the frequency of the audio clock.

17. The method of claim 16 wherein the determining a status of the buffer comprises receiving a from the audio data buffer a buffer status signal indicative of the status of the buffer.

18. The method of claim 16 wherein the determining a status of the buffer further comprises comparing a number of entries stored in the audio data buffer with upper and lower thresholds, wherein the status of the audio data buffer is determined to be approaching overflow if the number of entries is greater than the upper threshold.

19. The method of claim 16 wherein the determining a status of the buffer further comprises comparing a number of entries stored in the audio data buffer with upper and lower thresholds, wherein the status of the audio data buffer is determined to be approaching underflow if the number of entries is less than the lower threshold.

20. The method of claim 16 wherein the audio clock recovery circuit comprises a phase locked loop for recovering the audio clock from a reference clock received from the transmitter in accordance with an equation:
audio clock frequency=(M/N)*reference clock frequency
wherein M and N are values provided to the receiver by the transmitter and wherein the adjustment signal comprises an adjusted M value provided to the audio clock recovery circuit from the adjustment circuit.
